(19) United States
(12) Patent Application Publication
(10) Pub. No.: US 2019/0092499 A1
(43) Pub. Date: Mar. 28, 2019

(54) METHOD AND DEVICE FOR PACKAGING ELASTOMERIC PARTS

(71) Applicant: APTAR STELMI SAS, VILLEPINTE (FR)

(72) Inventors: Ghislain FOURNIER, LA ROCHELLE (FR); Philippe LE GALL, SENLIS (FR)

(73) Assignee: APTAR STELMI SAS, VILLEPINTE (FR)

(21) Appl. No.: 16/081,618

(22) PCT Filed: Mar. 31, 2017
(86) PCT No.: PCT/FR2017/050742

§ 371 Date: Aug. 31, 2018

(30) Foreign Application Priority Data
Apr. 1, 2016 (FR) 1652862

(51) Int. Cl. B65B 5/06; B65B 31/04; B65B 55/02; B65B 55/18; B32B 15/20; B32B 15/085; B32B 15/088; B32B 1/00; B65D 81/20

(52) U.S. Cl. CPC B65B 5/067; B65B 31/04; B65B 55/027; B65B 55/18; B32B 15/20; B32B 2439/46; B32B 15/088; B32B 1/00; B65D 81/203; B65B 2220/20; B32B 15/085

(57) ABSTRACT

A packaging method for packaging elastomer parts, such as stoppers for pharmaceutical containers, the method including the following steps: packaging parts in at least one primary bag made of material that is substantially permeable to vapor; packaging the at least one primary bag in a substantially rigid support member so as to form a unit; vapor-sterilizing the unit; and packaging the sterilized unit in at least one secondary bag, with a vacuum being applied between the at least one primary bag and the at least one secondary bag.

The present invention relates to a packaging method and device for packaging parts made of elastomer, such as stoppers for pharmaceutical containers.

Pharmaceutical containers for containing pharmaceuticals are generally closed, after filling, in leaktight and sterile manner by appropriate stoppers, typically made of elastomer materials, such as rubber. These stoppers can be provided ready for use, in which circumstance they may be packaged in a primary bag having good permeability to vapor, typically a bag made entirely, or in part, out of Tyvek®, which is a non-woven synthetic material that is manufactured from polyethylene fibers. The primary bag is then sterilized, while allowing vapor to pass therethrough during sterilization, and then the sterilized primary bag is inserted into an impermeable secondary bag. The term “vapor” is used to cover any gas used for sterilization purposes, including steam and chemical vapors.

Such a packaging system presents drawbacks. Thus, the primary bag is relatively fragile, with a risk of being damaged, in particular after sterilization. Furthermore, the primary bag, in particular when it is made out of Tyvek®, can potentially allow bacteria to pass therethough, before and/or after sterilization, in particular if it has imperfections. In order to overcome those drawbacks, a plurality of primary bags are generally provided, arranged one over another, which limits the above-mentioned risks, but does not eliminate them. Another drawback of the conventional packaging system is not being able to see any loss of integrity of the primary bag and/or of the secondary bag.

Documents FR 3 014 851, DE 3 717 916, DE 10 2007 056 261, and US 2013/118924 describe prior-art devices.

An object of the present invention is to provide a packaging method and device for packaging elastomer parts that do not have the above-mentioned drawbacks.

In particular, an object of the present invention is to avoid as much as possible the risks of bacterial contamination, before and/or after sterilization.

The present invention thus provides a packaging method for packaging elastomer parts, such as stoppers for pharmaceutical containers, the method comprising the following steps:
packaging parts in at least one primary bag made of material that is substantially permeable to vapor;
packaging said at least one primary bag in a substantially rigid support member so as to form a unit;
vapor-sterilizing said unit; and
packaging said sterilized unit in at least one secondary bag, with a vacuum being applied between said at least one primary bag and said at least one secondary bag.

The present invention also provides a packaging device for packaging elastomer parts, such as stoppers for pharmaceutical containers, the device comprising at least one primary bag, made of material that is permeable to vapor, receiving said parts, said at least one primary bag being packaged in a substantially rigid support member so as to form a sterilizable unit, said sterilized unit being packaged in at least one secondary bag with a vacuum being applied between said at least one primary bag and said at least one secondary bag.

Advantageously, said at least one primary bag is made entirely, or in part, out of Tyvek®.

Advantageously, said secondary bag comprises a plurality of layers, in particular a three-layer or four-layer structure.

Advantageously, said multilayer secondary bag includes a layer made of aluminum.

Advantageously, said multilayer secondary bag comprises a three-layer structure with an inner layer made of polyamide, a layer made of aluminum, and an outer layer made of polyethylene.

In a variant, said multilayer secondary bag comprises a four-layer structure with an inner layer made of polyethylene terephthalate, a layer made of aluminum, a layer made of polyamide, and an outer layer made of polyethylene.

In another advantageous variant, said multilayer secondary bag comprises a three-layer structure with an inner layer made of polyethylene, a layer made of polyamide, and an outer layer made of polyethylene.

In a first advantageous variant, said support member is an open chamber.

In a second advantageous variant, said support member is a closed chamber.

Advantageously, said support member is made, at least in part, of a material that is permeable to vapor.

In a variant, said support member is made of a material that is impermeable.

Advantageously, said support member includes at least one opening through which vapor passes.

These characteristics and advantages and others of the present invention appear more clearly from the following detailed description, given by way of non-limiting examples, and with reference to the accompanying drawing, and in which:

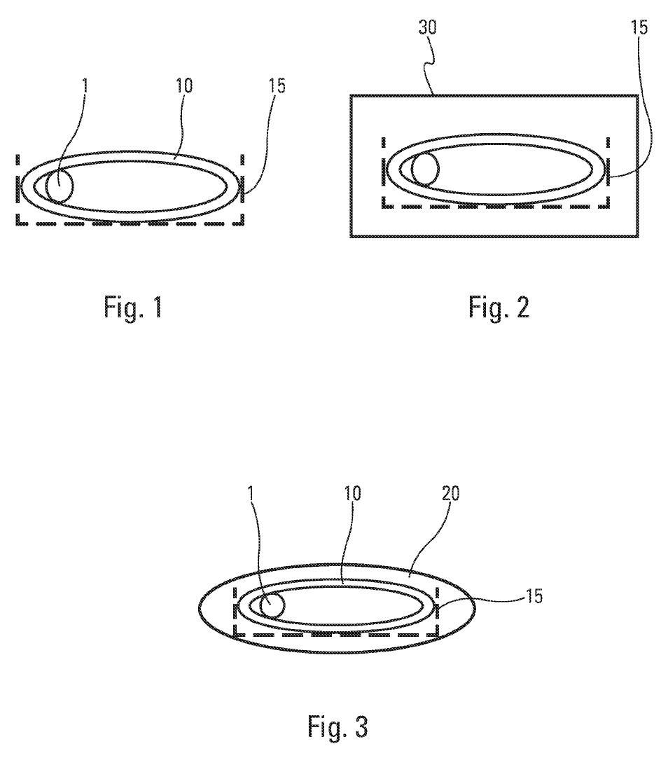

FIG. 1 is a diagrammatic view of a packaging device for packaging elastomer parts, in the initial packaging stage;

FIG. 2 is a diagrammatic view of the device in FIG. 1, in the sterilization stage; and

FIG. 3 is a diagrammatic view of the device in FIGS. 1 and 2, in the final packaging stage.

FIGS. 1 to 3 are diagrammatic, and naturally the shapes of the various elements are not representative of the real shapes or to scale. In particular, the parts may be of any number and of any shape, and the bags may also be of any shape and size.

In conventional manner, elastomer parts 1, such as stoppers for pharmaceutical containers, are packaged in a packaging device that includes a primary bag 10 that receives said parts directly. Optionally, a plurality of primary bags, in particular two bags, may be provided, arranged one inside the other so as to reinforce the protection of the elastomer parts.

Advantageously, the packaging device further includes a secondary bag 20 that receives said primary bag 10, as shown in FIG. 3. A plurality of secondary bags may also be provided, arranged one over another.

In the invention, a substantially rigid support member 15 is provided that receives said primary bag 10 before sterilization in a sterilization chamber 30.

The support member 15 may form an open chamber, e.g. being open-worked. By way of example, it may be formed by a grille or a box that is perforated, at least in part, with or without a cover.

The support member 15 may also form a closed chamber.

Preferably, the support member 15 is made of a material that is compatible with the parameters of a sterilization method. It may be made, at least in part, of a material that is permeable to vapor. In a variant, it may be made of a material that is impermeable. In particular for a material that is impermeable, the support member 15 should include at least one opening through which vapor can pass, e.g. a grille or small holes. The openings through which vapor can pass are advantageously dimensioned so that the parts are not stressed while the secondary bag is being compressed, typically by a few millimeters, possibly by about a centimeter. Optionally, it is possible to combine the use of a material that is permeable to vapor with openings through which vapor can pass, so as to optimize the sterilization of the parts arranged inside said support member.

Thus, the primary bag 10 containing the elastomer parts 1 is initially arranged in said support member 15, and then this unit is sterilized in a sterilization chamber 30.

The sterilized unit is then packaged in a controlled zone in the secondary bag 20.

An air vacuum is then created between the primary bag 10 and the secondary bag 20. The vacuum makes it possible to detect any possible problem of integrity, which would be revealed as a loss of vacuum, causing the said bags to become separated.

The presence of the support member 15 around at least part of said primary bag 10, protects said primary bag during various manipulations, thus limiting the risk of the primary bag 10 being degraded and/or damaged.

As a result of the primary bag 10 being arranged, at least in part, in a substantially rigid support member 15, it is also possible to avoid the elastomer parts 1 contained in said primary bag 10 being compressed while the secondary bag 20 is put under vacuum. When the support member 15 includes openings through which vapor can pass, it is desirable for the openings to be quite small so as to avoid the secondary bag deforming excessively by stretching while applying the vacuum.

The primary bag 10 is preferably made of a material having good permeability to vapor, typically a bag made entirely, or in part, out of Tyvek®.

The secondary bag 20 comprises a plurality of layers, in particular a three-layer or four-layer structure.

Advantageously, the multilayer secondary bag includes a layer made of aluminum. This makes it possible to guarantee the moisture content of the packaged parts. By way of example, the multilayer secondary bag may comprises a three-layer structure with an inner layer made of polyamide, a layer made of aluminum, and an outer layer made of polyethylene, or a four-layer structure with an inner layer made of polyethylene terephthalate, a layer made of aluminum, a layer made of polyamide, and an outer layer made of polyethylene.

If the moisture content of the packaged parts does not need to be guaranteed, the secondary bag 20 may comprise a multilayer structure that does not have a layer made of aluminum, e.g. a three-layer structure with an inner layer made of polyethylene, a layer made of polyamide, and an outer layer made of polyethylene.

It should be observed that the polyamide may have biaxial orientation.

Other materials and/or structures may be envisaged for the primary bag(s) 10 and/or the secondary bag(s) 20.

The invention is described above more particularly with reference to stoppers for pharmaceutical containers, but it could also apply to other types of elastomer parts, such as syringe pistons or syringe needle-guards, for example.

The present invention is described above with reference to a particular embodiment, but naturally it is not limited by said embodiment, but on the contrary, any useful modifications can be applied thereto by the person skilled in the art, without going beyond the ambit of the present invention, as defined by the accompanying claims.

1. A packaging method for packaging elastomer parts, such as stoppers for pharmaceutical containers, the method being characterized in that it comprises the following steps:
packaging parts in at least one primary bag made of material that is substantially permeable to vapor;
packaging said at least one primary bag in a substantially rigid support member so as to form a unit;
vapor-sterilizing said unit; and
packaging said sterilized unit in at least one secondary bag, with a vacuum being applied between said at least one primary bag and said at least one secondary bag.

2. A packaging device for packaging elastomer parts, such as stoppers for pharmaceutical containers, the device being characterized in that it comprises at least one primary bag, made of material that is permeable to vapor, receiving said parts, said at least one primary bag being packaged in a substantially rigid support member so as to form a sterilizable unit, said sterilized unit being packaged in at least one secondary bag with a vacuum being applied between said at least one primary bag and said at least one secondary bag.

3. The device according to claim 2, wherein said at least one primary bag is made entirely, or in part, out of Tyvek®.

4. The device according to claim 2, wherein said secondary bag comprises a plurality of layers, in particular a three-layer or four-layer structure.

5. The device according to claim 4, wherein said multilayer secondary bag includes a layer made of aluminum.

6. The device according to claim 5, wherein said multilayer secondary bag comprises a three-layer structure with an inner layer made of polyamide, a layer made of aluminum, and an outer layer made of polyethylene.

7. The device according to claim 5, wherein said multilayer secondary bag comprises a four-layer structure with an inner layer made of polyethylene terephthalate, a layer made of aluminum, a layer made of polyamide, and an outer layer made of polyethylene.

8. The device according to claim 4, wherein said multilayer secondary bag comprises a three-layer structure with an inner layer made of polyethylene, a layer made of polyamide, and an outer layer made of polyethylene.

9. The device according to claim 2 wherein said support member is an open chamber.

10. The device according to claim 2 wherein said support member is a closed chamber.

11. The device according to claim 2, wherein said support member is made, at least in part, of a material that is permeable to vapor.

12. The device according to claim 2, wherein said support member is made of a material that is impermeable.

13. The device according to claim 2, wherein said support member includes at least one opening through which vapor passes.
